(19) United States
(12) Patent Application Publication
(10) Pub. No.: US 2010/0129143 A1
(43) Pub. Date: May 27, 2010

(54) FASTENER FOR DETACHABLY CONNECTING A PROFILE TO A COUNTERPROFILE

(76) Inventors: Dieter Hackenberg, Witten (DE); Gerd Vieler, Iserlohn (DE)

Correspondence Address: Horst Kasper, 13 Forest Drive, Warren, NJ, 07059, US

(21) Appl. No.: 12/452,029

(22) PCT Filed: May 8, 2008
(86) PCT No.: PCT/EP2008/003682

§ 371 Date: Jan. 27, 2010

(30) Foreign Application Priority Data
Jun. 11, 2007 (DE) 10 2007 027 381.0
Dec. 6, 2007 (DE) 10 2007 059 172.3

(51) Int. Cl. F16B 5/06

(52) U.S. Cl. 403/282

(57) ABSTRACT

The invention relates to a fastener (10.1) comprising a housing with a plate (40.1) accommodated therein and an eccentric pin (30) rotationally mounted therein. The plate (40.1) has on the outer end thereof at least one hook (45.1) and a bevel (51.1) supported on a contact point (55.1) of the housing. In order to increase the stability of the fastener (10.1) and to allow a cost-effective production, the invention proposes that the housing be structured as a one-piece sleeve (20.1) open on both ends produced by bending a sheet cutout (60.1) multiple times. The two sheet ends of the sheet cutout adjoining one another in the sleeve (20.1) are connected to one another. The connection insures that an overturning of the eccentric disk (31) does not cause any bulging (58) of the sleeve (20.1). At least one first bend (78.1) is provided at least on the front end of the sleeve, producing a contact point (55.1) for the plate bevel (51.1).

The invention is directed to a fastener for disengageably connecting of a profile to a counter profile. The counter profile exhibits an undercut groove and the profile exhibits a receiver for a housing of the fastener. An eccentric bolt is rotary supported in the housing, wherein the eccentric bolt in addition to the cam disk disposed in the interior of the case also exhibits a bolt head projecting from the housing and serves for the actuation of rotation of the eccentric bolt. A plate is disposed in the housing, wherein the plate is longitudinally shiftable by the cam disk between a pullout position and a plug in position. At least one hook is disposed at the outer end of the plate, wherein the hook projects from the housing. There is a bevel at the plate running inclined to the longitudinal shifting, wherein the plate is supported at a contact point of the housing. This has the consequence that upon plugging in the hook runs cross behind the groove wall in the counter profile. An inner section at the plate is penetrated by the eccentric bolt.

Such a fastener is known from the German printed Patent document DE 3128595. The known case of the fastener is formed as a box with at least regionally walls on all sides, apart from breakouts for mounting its individual components together, and therefore has to be produced by injection molding, for example by zinc die casting.

Although the known fastener has proven its value, in some application cases there is noticed an insufficient strength of the fastener. In addition production and assembly costs of the fastener are undesirably high.

It is an object of the present invention to develop a fastener of the kind indicated in the preamble of claim 1, which fastener is economically and distinguishes itself by a high strength. This is accomplished according to the present invention by the features recited in claim 1, which features have the following special importance.

According to the present invention, the fastener is a single piece housing open on two end sides, wherein the housing is generated by multiple bending of a sheet metal blank. In fact, a suitable working material with a sufficient high strength can be employed as material for the sheet metal blank. In particular, steel has proven itself here. The sheet metal ends of the sheet metal blank, abutting against each other and generated during bending of the case, are connected to each other, wherein the connection is directed opposite to a widening of the case resulting from overturning of the cam disk. A bending off of the angles from the sheet metal blank is thereby prevented in the case and the shape of the case is thereby stabilized. This feature results in a surprisingly high strength. At least at the front case end at least a first angling off of wall end pieces is furnished in order to generate a contact point for the plate bevel.

An economic production of the case with a high strength can be achieved at least in cases where the two sheet metal ends are held together by shape matching and, as proposed in claim 2, exhibit two formed edges running in the longitudinal direction of the case, wherein the two formed edges have a border profile undercut and complementary to each other. Then there is present a face flush shape matching connection. One obtains a space saving smooth contour of the case, wherein the contour of the case can be introduced without problem into a correspondingly small dimensioned receiver in the profile to be connected.

A leaf spring is disposed at the inner end of the plate according to an embodiment example, wherein the leaf spring presses outwardly the bolt head cross to the longitudinal shifting direction and out of the case. A cross force effective at the bolt head and cross directed is thereby generated. A so-called pushbutton mounting and pushbutton demounting is thereby possible. The free end of the leaf spring supports itself at an inner face of the case and slides along this support face upon longitudinal shifting of the plate. The leaf spring end assumes two extreme positions during the longitudinal shifting. There is a starting position, which is present in the pullout position of the plate. The peculiarity of this embodiment example comprises that the support face for the leaf spring end is furnished with a rising ramp at least in certain regions, wherein the ramp gets higher in the direction of the final position. The leaf spring end rests on the ramp in the final position. A longitudinally directed longitudinal force effective in the pullout sense is generated between the inclined leaf spring end the ramp, wherein the longitudinal force acts on the plate. The latter has the following consequences.

The case as well as the plate with its hooks and its bevels are preferably comprising steel for reasons of strength. Problems exist between the bevels of the plates and their housing contact positions during the pullout motion of the plate. The bevels of the plates slide only heavily at the contact positions of the case based on unfavorable friction values. Operational disturbances occur when one wishes to transfer the hook at the plate from its plug in position into a pullout position. Since however a longitudinal force acting in the pullout sense is generated in the plate according to the present invention, this longitudinal force can advance the sliding motion of the bevel of the plate. This longitudinal force supports the push force generated by the cam disk. The means for this longitudinal force of the plate are equally self generated, that is by the contact between the inclined leaf spring and the ramp. Since such a ramp can be generated simply by a dent in the wall of the case, the present invention does need neither additional device components nor additional space. Neither the handling nor the assembling or disassembling are interfered with by the recited inventive steps. It is decisive that the fastener according to the present invention as mentioned is easily actuable and operates reliably.

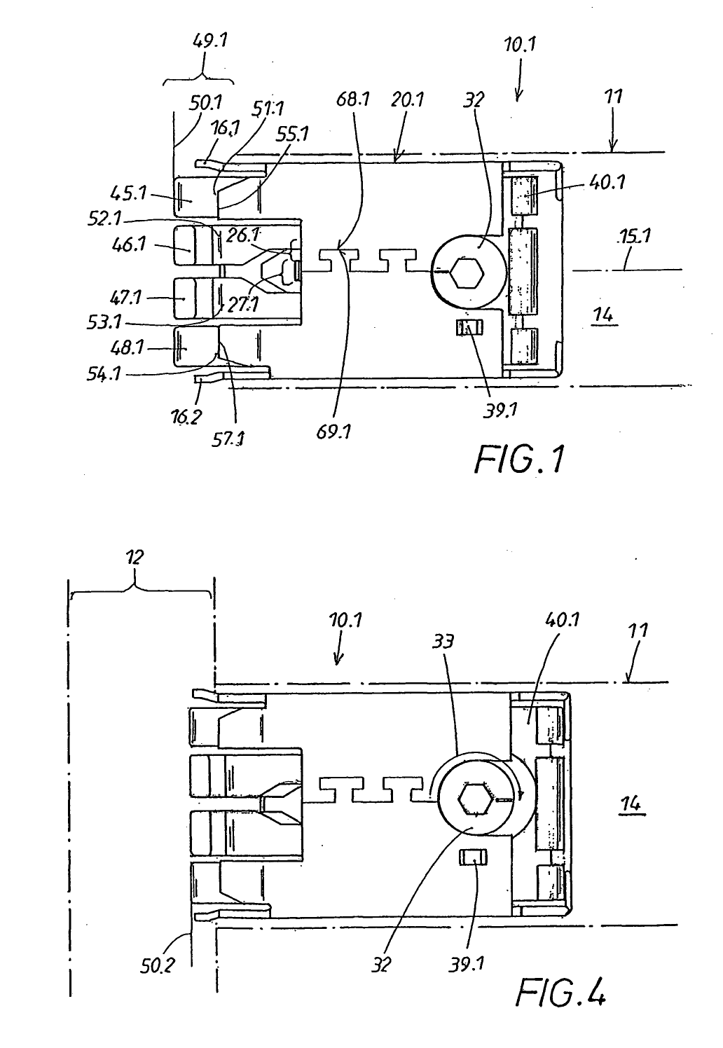

Additional steps and advantages of the invention result from the further claims, the description and drawings. The invention is represented by four embodiment examples in the drawings. A first embodiment example is shown in FIGS. 1 through 14, wherein the plate of the fastener is subdivided into four tongues with four hooks in its outer end region and therefore forms a four hook fastener. There is shown in detail:

FIGS. 1 through 3 show the front view, the rear view and the top planar view onto such a four hook fastener, wherein the plate is disposed in a push out position,

FIGS. 4 through 6 show the same four hook fastener in the analogous front view, rear view and top planar view, wherein the plate is disposed in its plug in position in the housing,

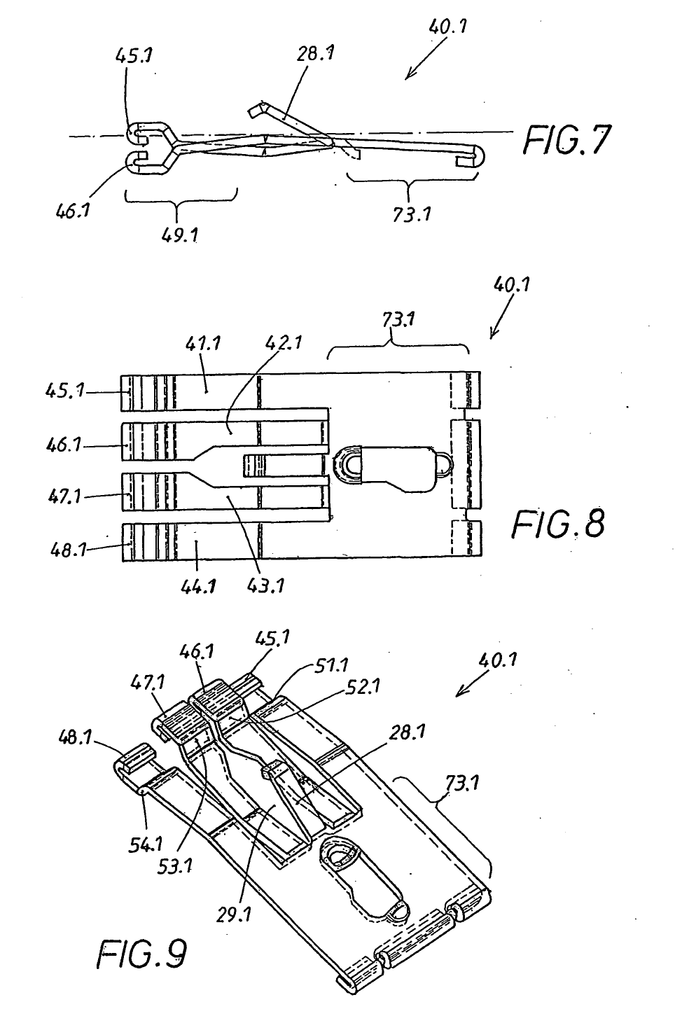

FIG. 7 shows the top planar view onto the demounted plate of the four hook fastener of FIGS. 1 through 6,

FIG. 8 shows a top planar view onto the plate of FIG. 7,

FIG. 9 shows the perspective view of the plate of FIG. 7 or 8,

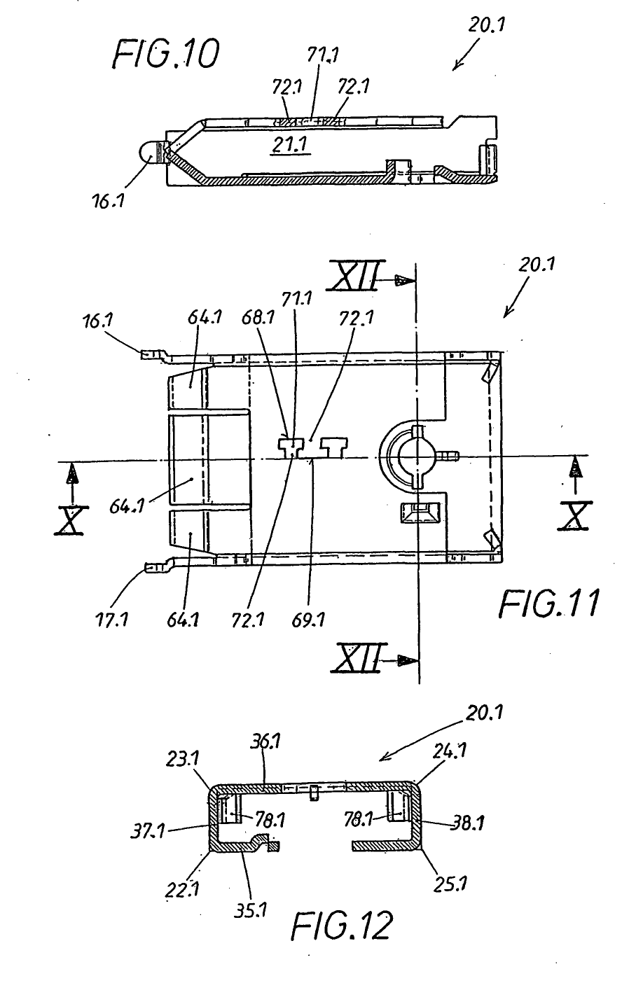

FIG. 10 shows a longitudinal section through the housing of the four hook fastener shown in FIGS. 1 through 6 along the section line X-X of FIG. 11,

FIG. 11 shows a top planar view onto the case shown in FIG. 10,

FIG. 12 shows a cross-sectional view of the case shown in FIG. 11 along the section line XII-XII shown in FIG. 11,

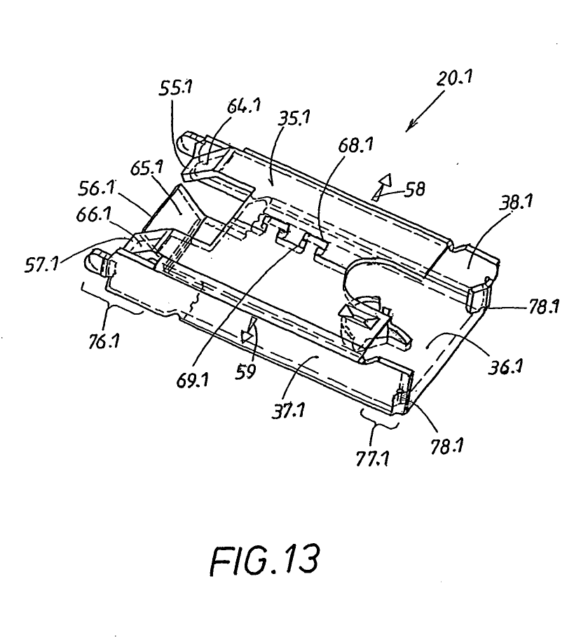

FIG. 13 shows a perspective view of the case illustrated in FIGS. 10 through 12,

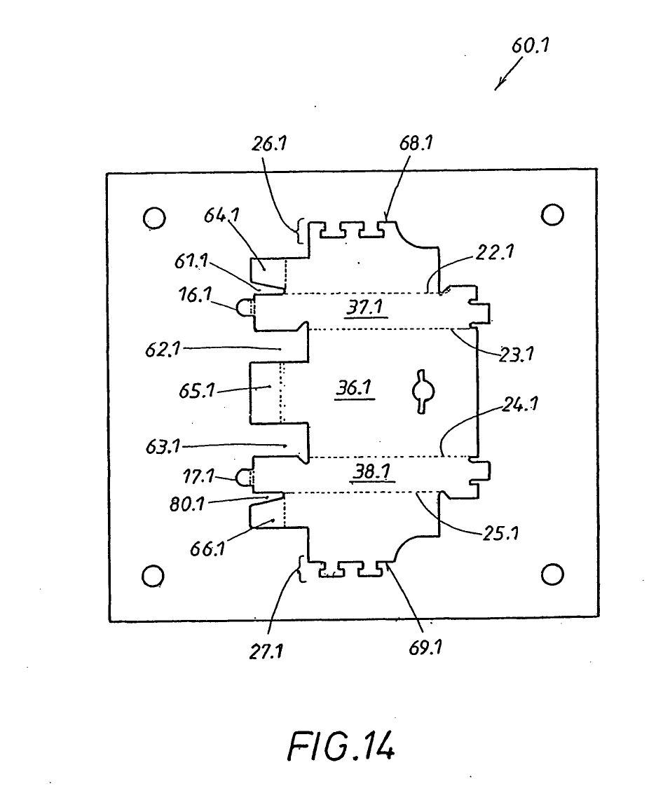

FIG. 14 shows a developed view of a sheet metal blank for production of the housing, wherein the canting off or, respectively, the bending lines are illustrated by dash-dotted lines in the blank.

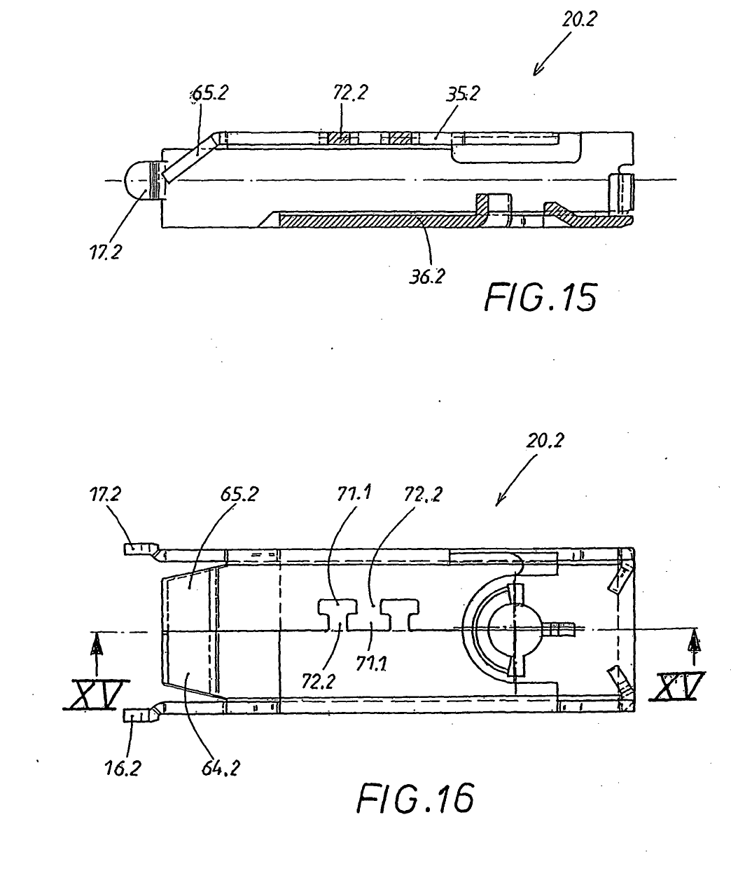

Individual components of an alternative embodiment of the fastener according to the present invention are shown in FIGS. 15 through 18, wherein the plate of the fastener exhibits two tongues bent at a right angle in an opposite sense to each other in the plate bevel and with the bending of the hooks in an opposite sense to each other. Such a two hook fastener is not shown in detail in the drawings, however its components are shown. The drawings show:

FIG. 15 shows a longitudinal section view through a housing of such a two hook fastener along the section line XV-XV of FIG. 16 in analogy to FIG. 10,

FIG. 16 shows a front elevational view of the case forming the housing in analogy to FIG. 11,

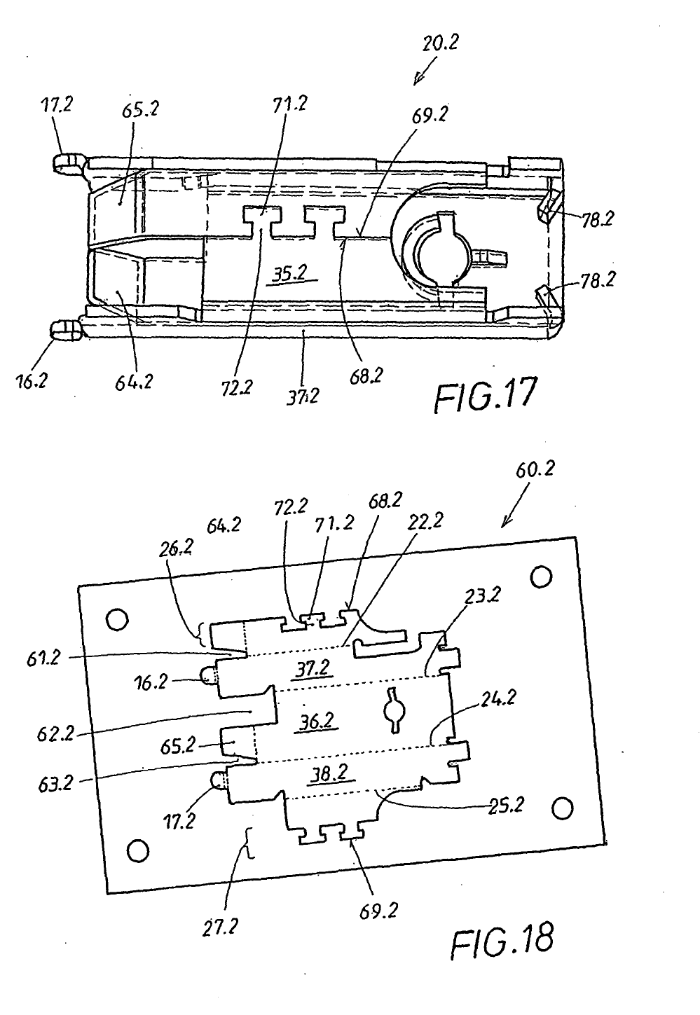

FIG. 17 shows a perspective view of the case shown in FIGS. 15 and 16 at a smaller scale relative to FIGS. 15 and 16, and

FIG. 18 shows a planar developed view of the sheet metal blank, from which blank the case visible in FIGS. 15 through 17 is generated by canting off and bending off.

Furthermore a third embodiment example of the invention is shown in:

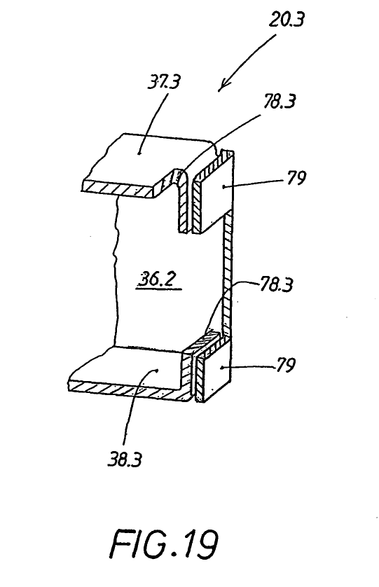

FIG. 19 shows a perspective view of only the rear case end and in fact in the shape of double angling off, which generates a particular shape stable support in the fastener, into which the inner end of the plate is moved in the plug in position and thereby blocks the pushbutton actuation mentioned in claims 13 of the bolt head. Thus the disassembly of the fastener from the profile receiving the fastener can be reliably prevented.

Finally there is shown a four embodiment example, and in fact with a ramp at the support face for the leaf spring end:

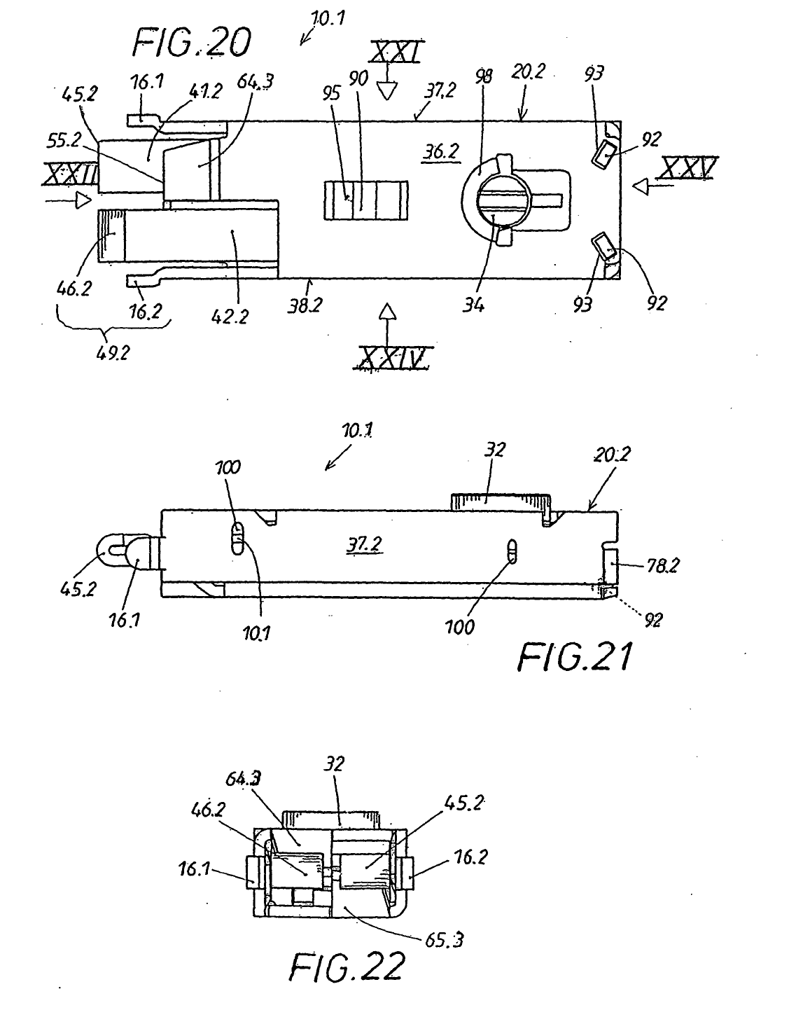

FIG. 20 shows the rear view of the fastener according to the present invention prior to its assembly in a receiver of the profile,

FIG. 21 shows a top planar view onto the narrow side of the case in the direction of view of the arrow II (translators remark: should be XXI) of FIG. 1 (translators remark: should be 20),

FIG. 22 shows a first end view of the fastener of FIG. 1 (translators remark: should be 20) onto the end furnished with the hooks into view direction of the arrow III (translators remark: should be XXII) of FIG. 1 (translators remark: should be 20),

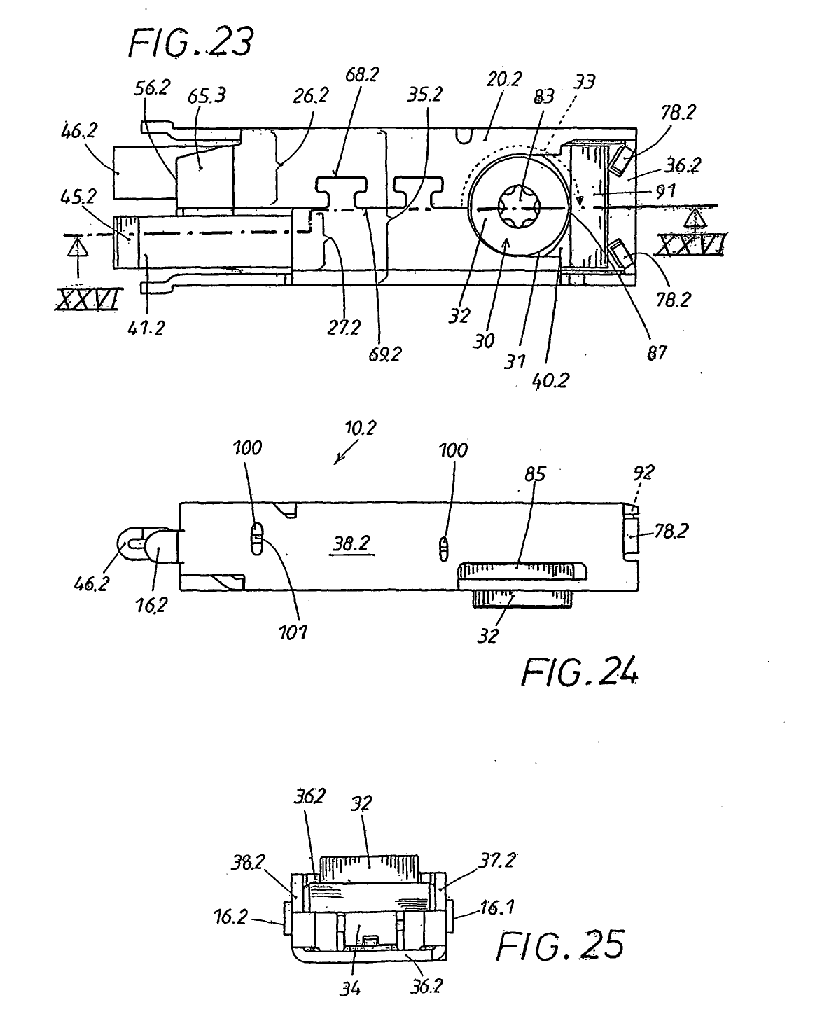

FIG. 23 shows a front elevational view of the fastener shown in FIG. 1 (translators remark: should be 20) onto the broad side of the case not visible in FIG. 1,

FIG. 24 shows a top planar view onto a second narrow side of the fastener of FIG. 1 (translators remark: should be 20) in the direction of view of the arrow V (translators remark: should be XXIV) presented there,

FIG. 25 shows a top planar view onto the rear end furnished with the eccentric bolt of the fastener shown in FIG. 1 (translators remark: should be 20), and in fact in the direction of view of the arrow V (translators remark: should be XXIV) presented there,

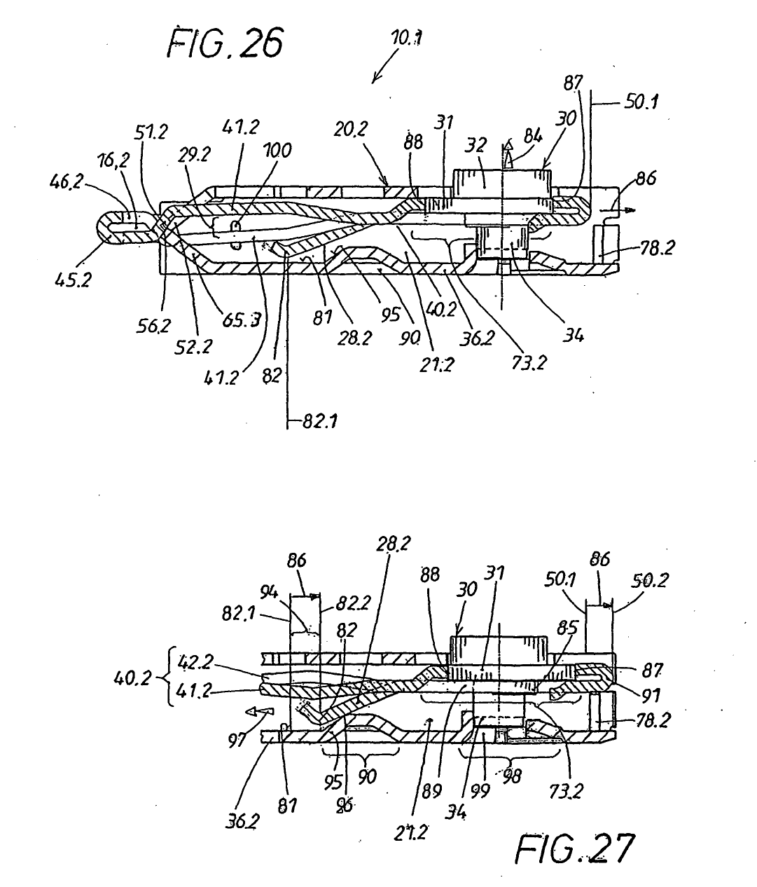

FIG. 26 shows a longitudinal section through the fastener of FIG. 4 (translator's remark: should be 23) along the there presented jumping section line VII-VII (translators remark: should be XXVI-XXVI), if the plate furnished with the hooks is disposed in its plug in position,

FIG. 27 shows the rear region of the longitudinal section shown in FIG. 7 (translators remark: should be 26) if the plate furnished with hooks is disposed in its final plug in position.

The fastener 10.1 comprises of two parts, namely out of the sheet metal blank 60.1 viewable in FIG. 14 and of the plate 40.1 visible in FIG. 9 the sheet metal blank 60.1 is formed as a single piece and is formed to a case 20.1 by bending at the edges 22.1, 23.1, 24.1, 25.1 as can be recognized in FIG. 13.

The sheet metal blank 60.1 has specially formed edges 68.1 at the sheet metal ends 26.1, 27.1 for providing better support after the bending, wherein the specially formed edges 68.1 can be brought into working connection with the corresponding counter pieces 69.1 for the better support after the bending, in order to maintain the sheet metal blank form matching and/or force matching after the bending.

The end flaps 64.1, 65.1, 66.1 are furnished, which are bent in opposite directions, in order to limit the freedom of motion of the plate 40.1 in the sheet metal blank 60.1. On the oppositely disposed side, the freedom of motion of the plate 40.1 is limited by the canting 78.1.

Such a mounted fastener 10.1 is shown in FIG. 1. Sensibly this fastener 10.1 is inserted into a profile 11 in order to hold this profile 11 in the following by way of the fastener 10.1 at a counter profile 12. For this purpose the plate 40.1 is supported movably in the case 20.1 formed out of the sheet metal blank 60.1 and the plate 40.1 can be shifted in the longitudinal direction 15.1 of the case.

The case 20.1 has canted off case noses 16.1, 16.2, for better guiding the fastener 10.1 at a counter profile 12, wherein the case noses 16.1, 16.2 are applied at the same outer end 49.1 of the case 20.1, wherein also the hooks 45.1, 46.1, 47.1, 48.1 of the plate 40.1 are applied at the case 20.1. These hooks are arranged in an opposite sense in order to be able to grip firmly into a corresponding counter profile 12 and then to attach the fastener 10.1 in the receiver of 14 of the profile 11 with the profile 11 at a corresponding counter profile 12. The hooks 45.1, 46.1, 47.1, 48.1 here grip into an undercut groove 13 at the counter profile 12.

During the pulling tight process illustrated in FIG. 4, the bolt head 32 of the eccentric bolt 30 is rotated. The plate 40.1 of the fastener 10.1 is shifted in longitudinal direction based on the cam disk 31 seated under the bolt head 32 such that the hooks 45.1, 46.1, 47.1, 48.1 pull in the counter profile 12 to the profile 11. The path of the cam disk 31 is limited by an inner projection 39.1 at the fastener 10.1 such that the bolt head 32 cannot be rotated continuously. The case 20.1 has canted off bevel faces 51.1, 52.1, 53.1, 54.1, which, upon cooperation with the tongues 41.1, 42.1, 43.1, 44.1 of the plate 40.1, spread the hooks disposed at the ends of these tongues in order to supportingly spread the hooks 45.1, 46.1, 47.1, 48.1 during the longitudinal motion to for aiding the hooking into the counter profile 12. This co-operation of the bevel faces 51.1, 52.1, 53.1, 54.1 with the tongues 41.1, 42.1, 43.1, 44.1 occurs through the corresponding contact points 55.1, 56.1, 57.1.

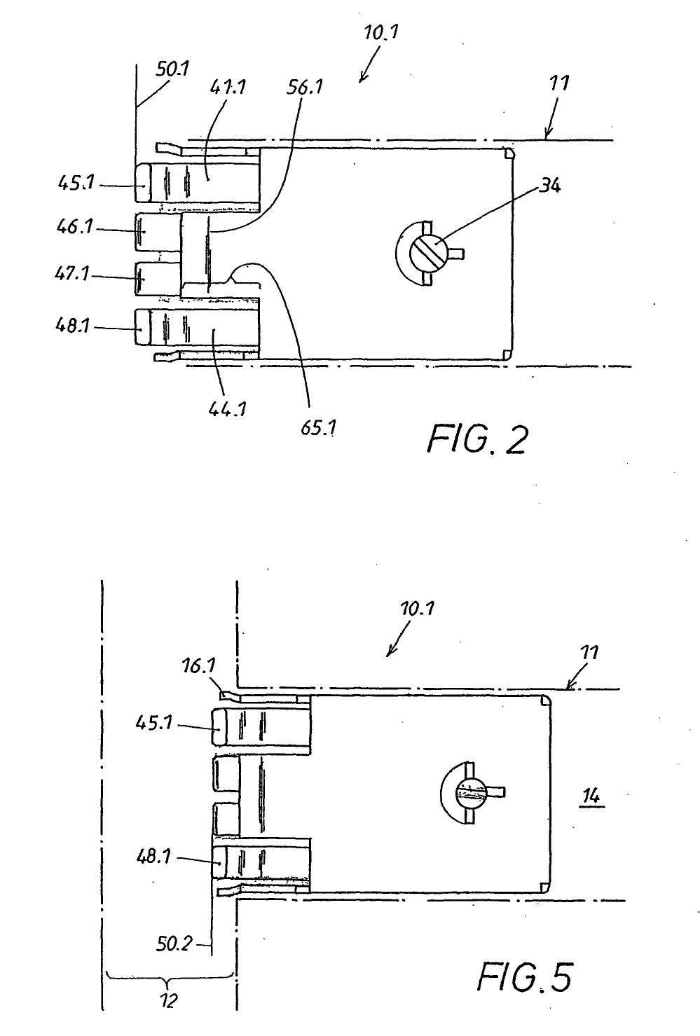

FIG. 2 and FIG. 5 illustrate again what is shown in FIG. 1 and FIG. 4 as seen from the opposite side. The journal 34 of the eccentric bolt 30 is visible in this view, which eccentric bolt 30 transfers the fastener 10.1 from the open position of FIG. 1 or, respectively, FIG. 2 into the closed position of FIG. 4 or, respectively, FIG. 5 through the rotary actuation 33. The pullout position 50.1 and the plug in position 50.2 are also here again clearly shown.

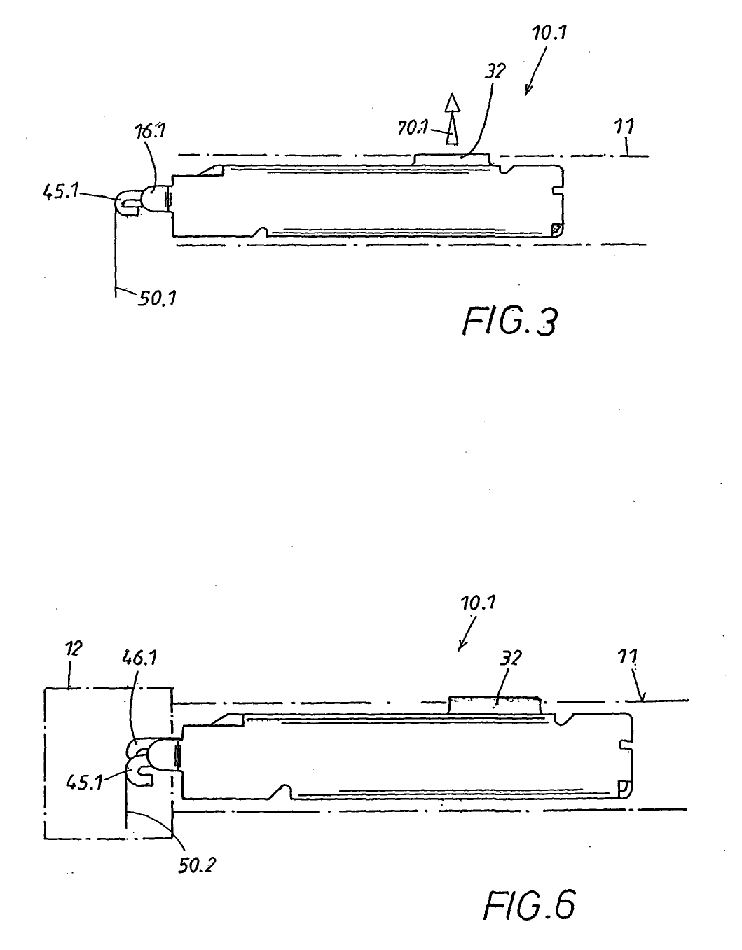

FIGS. 3 and 6 clarify the plug in position 50.2 or, respectively, the pullout position 50.1 again in a side view. It can be additionally recognized here that a spring loading 70.1 cross to the profile 11 is built up during tight pulling of the fastener to the eccentric bolt 30, which spring loading 70.1 holds the fastener in the profile 11.

The plate 40.1 is separately considered from the case 20.1 and this in side, front and perspective views. A leaf spring 28.1 can be recognized in addition to the tongues 41.1, 42.1, 43.1, 44.1, which leaf spring serves to enable the above-mentioned cross force 70.1 to the profile 11 upon pulling tight the fastener 10.1. The plate inner section 73.1 can be clearly seen in addition in these three figures, which plate inner section 73.1 is disposed at the opposite end of the outer end 49.1.

The case 20.1 shows individually in three views of FIGS. 10, 11, and 12 and this time the case 20.1 in the FIGS. 10, 11 and 12 is shown in the same way as with the FIGS. 7, 8, and 9. These three views allow an insight also into the interior case 21.1 of the case 20.1. The edges 68.1, 69.1 gripping into each other are presented here again, which edges are presented here as a widened head 71.1 or, respectively, as a narrowed neck 72.1.

The broad sides 35.1, 36.1 and the associated narrow sides 37.1, 38.1 generated after the canting of the sheet metal blank 60.1 are also clearly shown here with additional reference to FIG. 13 and FIG. 14. The plate 40.1 with the plate inner section 73.1 and the plate cutout 29.1 is then laid into this case 20.1, wherein the hooks 45.1, 46.1, 47.1, 48.1 are disposed at the plate cut out 29.1. Additionally, it can be recognized in FIG. 13 that an expansion of the narrow sides 37.1, 38.1 in the direction of the forces 50 (translator's remark: should be 58), 59 is prevented during hard turning of the eccentric bolt 30.

The free cut 61.1, 62.1, 63.1, and 80.1 caused by the production conditions can be recognized in FIG. 14 additionally to the end flaps 64.1, 65.1, 66.1. An actuator 75 can be furnished at the bolt head 32 in order to be able to unbolt again easier the fastener 10.1, wherein the actuator 75 transfers the fastener 10.1 by pressing into the unbolted position. The case 20.1 of the fastener 10.1 at its front case end 76.1 can therewith be easier separated from the counter profile 12. The case 20.1 itself can then completely be taken out of the profile 11 including the rear case end 70.1.

FIGS. 15 through 18 show another embodiment of the fastener 10.1, wherein the case 20.2 is formed somewhat narrower as compared with the preceding figures. The case 20.2 can be recognized with its sheet metal blank 60.2 in FIG. 18. All elements of the sheet metal blank 60.2 can here also again be recognized, such as the end flaps 64.2, 65.2, the production caused free cuts 61.2, 62.2, 63.2 and the noses 16.2, 17.2 of the case 20.2. The case 20.2 with its interior 21.2 of the case 20.2 shown in FIG. 17 is generated by bending the sheet metal blank 60.2 at the edges 22.2, 23.2, 24.2, 25.2. The end flaps 64.2, 65.2 are here also beveled in order to cooperate with their end regions 26.2, 27.2 with the plate 40.2 laid into the case 20.2. The broad sides 35.2, 36.2 as well as the narrow sides 37.2, 38.2 result then also again by bending.

The corresponding plate 40.2 contains also two tongues 41.2, 42.2 with the corresponding hooks 45.2, 46.2 at the outer end 49.2 of the plate 40.2. The plate 40.2 has furthermore the bevels 51.2, 52.2, which bevels exert the already mentioned spreading effect through the contact positions 55.2, 56.2 and the end flaps 64.2, 65.2 of the case 20.2.

The case is again held together by the two edges 68.2, 69.2, which edges 68.2, 69.2 enter into operating connection with a shape matching through broadened heads 71.2 and narrowed necks 72.2 as shown in FIG. 17.

The case 20.2 includes again a front case end 76.2 and a rear case end 77.2, wherein cantings 78.2 are furnished at the rear case end 77.2 for limiting the motion of the plate 40.2 in the case 20.2.

Finally, FIG. 19 shows that the canting 78.3 at the rear case end 77.2 can be angled by also 90 degrees and can be held with a second canting 79.

A modified embodiment form of the embodiment form shown already in the FIGS. 15 through 18 is shown in the drawings to the last embodiment example (FIG. 20 through FIG. 27). In the shown embodiment example (FIG. 20 through FIG. 27) however the complete fastener is shown and not only the case shown in FIGS. 15 through 17, but also the profiled plate furnished for the interior of the case. An analogous plate 40.1, however with four hooks 45.1 through 48.1, is shown in the first embodiment example and in fact in the demounted state in the therewith associated FIGS. 7 through 9. As can be best recognized from FIG. 23, the fastener 10.1 is composed of three components, namely a single part case 20.2 forming a housing, a profiled plate 40.2 disposed in the interior 21.2 of the case, and an eccentric bolt 30 rotary supported in the case. According to FIG. 26, the initial section of plate 40.2 is subdivided into two tongues 41, 42, wherein a plate cut out 29.2 is disposed between the tongues 41, 42 and wherein the plate cut out 29.2 can be taken from the analogous FIG. 9. This plate cut out 29.2 serves for forming a canted running leaf spring 28.2 in an analogous way as shown in FIG. 9. In each case, a hook 45.2, 46.2 is disposed at the outer free end region of the two tongues 41.2, 42.2, which hooks 45.2, 46.2 are cranked in an opposite sense to each other and project in the assembled case out of the case 40.2 (translator's remark: should be 20.2) according to FIG. 20.

In a use situation discussed in a 10.1 with its case 40.2 (translator's remark: should be 20.2) is mounted in the receiver of a profile not shown in detail. The eccentric bolt 30 cooperates with this assembly. The eccentric bolt 30 is furnished with a cam disk 31 disposed in the interior 21.1 of the case and with a bolt head 32 projecting from the case 20.2. A rotary stop 85 and the journal 34 follow to the cam disk 31 in the interior 21.2 of the case, wherein the journal is here rotary supported in a particular way to be described in the following in more detail in a rear case wall 36.2, which case wall 36.2 is generated by the broad sides of the case 20.2. The bolt head 32 has a plug receiver 83 recognizable from FIG. 23 for a plug tool on the view side, wherein in the use case a rotary actuation 33 of the eccentric bolt 30 indicated in FIG. 23 can be performed with the plug tool. All this has the following effect.

According to FIG. 26 the eccentric bolt 30 passes through a breakout 89 in the inner section 73.2 of the plate 20.2 (translator's remark: should be 40.2). The cam disk 31 is supported face wise at the inner section 73.2. The already mentioned leaf spring 28.2 is seated at the plate inner section 73.2, wherein the leaf spring 28.2 is supported at its free end 82 at the inner face 81 of the rear case wall 36.2 in an operational situation of FIG. 7. The rear case wall 36.2 is subjected to spring tension and generates a spring loading in the sense of the force arrow 84 of FIG. 7 onto the bolt head 32. The bolt head 22 snaps into a correspondingly dimensioned profile opening after the previously recited mounting in the profile receiver. The spring loading 84 can be designated as a “cross force” relative to the longitudinal shifting direction 86. The bolt head 32 operates like a “pressure button” based on this cross force 84. The bolt head 32 has to be pressed backward into the interior of the case like a pressure button in a counter direction to the cross force 84 for the mounting the fastener 10.1, until the bolt head 32 of the fastener 10.1 has released the profile opening. Then the fastener 10.1 can be pulled out of the profile receiver.

The fastener 10.1 protrudes with its outer end marked with 49.2 in FIG. 20 out of the profile in the incorporated state of the fastener 10.1 in order to therewith be plugged in into an undercut groove of a counter profile not shown in detail. In addition to the two hooks 45.2, 46.2 also two case noses 16.1, 16.2 disposed in the region of the outer end 49.2 function here as insertion plug parts. The case noses 16.1, 16.2 are cranked to each other in a mirror image wherein one case nose is generated by extension of the case narrow wall 37.2 and the other case nose 16.2 is generated by a corresponding extension of the oppositely disposed case narrow wall 38.2 as seen in FIGS. 20 and 24.

The mounted fastener 10.1 should take of a holding together between the profile and the counter profile, which holding together is accomplished by a combined spreading and plug in motion of the two end side hooks 45.2, 46.2. The longitudinal shifting 86 of the plate 40.2 shown in FIGS. 26 and 27 is a trigger therefore. This occurs by the previously mentioned rotary actuation 33 or the eccentric bolt 30. A pullout position 50.1 of the plate 40.2 is marked by an auxiliary line in FIG. 26. In this case the two in mirror image to each other running hooks 45.2, 46.2 are aligned with the case noses 16.1, 16.2. This can also be recognized from FIGS. 21 and 24. The fastener 10.1 mounted in the profile can be plugged into or pulled out of the groove of the counter profile in the pullout position. The cam disk 31 rests with its circumference on an inner and on an outer carrier shoulder 87, 88 of the plate 40.2. The carrier shoulders 87, 88 are turned toward the recited plate breakout 89 as illustrated in FIG. 27. While the outer carrier shoulder 88 is generated by a dent in the plate profile, the inner carrier shoulder is formed by the free leg edge of a backward folded loop 91.

The eccentricity of the cam disk moves the plate 40.2 inwardly through the recited rotary actuation 33. Thus, the recited longitudinal shifting 86 occurs. The plug in position 50.2 of the plate 40.2 is accomplished after the longitudinal shifting 86 as illustrated by the further auxiliary line in FIG. 27. Here a spreading of the two hooks 45.2, 46.2 occurs, wherein the two hooks 45.2, 46.2 are moved cross behind the recited undercut groove wall in the counter profile. This way the holding together between the profile and the counter profile are generated through the fastener 10.1.

The spreading of the hook occurs in the course of the longitudinal shifting 86 and is a performed by an interaction between the plate 40.2 and the case 20.2. The two tongues 41.2, 42.2 have two bevels 51.2, 52.2 running relative to each other in an opposite sense in the front plate region, wherein the two bevels 51.2, 52.2 springingly support themselves in each case at one of two end flaps 64.3, 65.3 as can be recognized from FIGS. 20 and 23. The contact points 55.2, 56.2 recognizable from FIGS. 20 and 23 of the tongue bevels 51.2, 52.2 occur at the edges of the end flaps 64.3, 65.3. The previously mentioned spreading of the hooks occurs during the longitudinal shifting 65, since the contact points 55.2, 56.2 slide along the bevels 51.2, 52.2 having an opposite sense relative to each other.

The case 20.2 is generated by a multiple bending of a sheet metal blank, wherein the sheet metal blank preferably consists of steel. This way the corner regions of the case 40.2 (translator's remark: should be 20.2) exhibit a rectangular profile. Abutting sheet metal ends are generated in the sheet metal cutouts through this rectangle folding. The two sheet metal ends 26.2, 27.2 form the front case broad wall 35.2 recognizable in FIG. 23 and have two complementary relative to each other running edges 68.2, 69.2 with an undercut edge profile in the region of the wall middle. A shape matching of the front case broad wall 35.2 occurs. The single piece rectangular shaped closed case 20.2 is generated in this way.

In each case a shoulder 78.2 is generated in extension of the two case narrow walls 37.2, 38.2 according to FIGS. 21 and 24. The two shoulders 78.2 are angled off relative to each other and point with their shoulder ends toward each other as is shown in FIG. 23. These shoulders 78.2 are in each case furnished with a formed on tappet 92, wherein the tappet 92 engages in each case in a hole 93 of the neighboring case broad wall 36.2 as shown in FIG. 20. The angle position of the two shoulders 78.2 is thereby stabilized.

These shoulders 78.2 perform a support function in the plug in position 50.2 as seen in FIG. 27. The plate 40.2 with the end piece of its inner section 73.2 supports itself at the upper edge of the angled shoulder 78.2 in the plug in position 50.2. The press in motion of the eccentric bolt into the interior 21.2 of the case is blocked, since the eccentric bolt 30 with its cam disk 31 rests at the inner section 73.2. The bolt head 32 cannot be pressed in the recited counter direction to its spring loading 84 of FIG. 26 into the plug in position 15.2 (translator's remark: should be 50.2) of FIG. 27. The recited push button effect of the bolt head 32 is set to be ineffective. The fastener 10.1 is thereby secured in its mounted position in the profile. The holding together of profile and counter profile through the fastener 10.1 is also thereby completed.

One starting position 82.1 of the free leaf spring end 28.2 is marked by a first auxiliary line in FIGS. 26 and 27. This characterizes the position of the leaf spring 28.2 in the plug in position 50.1. Also the position of the free spring end 82 is changed during the plate longitudinal shifting 86 as shown in FIG. 27 and comes to rest in the end position marked with the second auxiliary line 82.2. The spring end 82 slides over the support face region between the two positions 82.1, 82.2 and characterized with 94 in FIG. 27 during the longitudinal shifting 86. A ramp 95 is disposed in at least one part piece of this support face region 94 according to the invention, wherein the ramp rises in the direction of the end position 82.2.

This ramp 95 is generated by a dent 90 in the case broad wall 35.2 in the present case. The dent 90 projects into the interior 21.2 of the case and generates the desired ramp 95 with its front flank. The free spring end 82 is disposed still at a distance to the ramp 95 according to FIG. 26, wherein the starting position 82.1 of the leaf spring 28.2 is present. These changes however in the end position 82.2 of FIG. 27. A contact point 96 results based on the interaction between the inclined running leaf spring 28.2 and the ramp 95, wherein a longitudinally directed longitudinal force 97 effective in the pullout sense is generated on the plate 40.2 at the contact point 96. The free spring end 82 has lifted off from the inner face 81 of the case broad wall 36.2 because of the ramp 96 (translator's remark: should be 95), wherein a higher spring force prevails in FIG. 27 as compared with the pullout position 50.1 in FIG. 26. The spring end 82 assumes a deeper lying contact position outside of the dent 90 at the wall inner face 81 in the pullout position 50.1 where as mentioned the starting position 82.1 is present.

The previously mentioned longitudinal force 97 becomes effective in the return rotary motion of the bolt head 32 having an opposite sense relative to the rotary motion 33 of FIG. 23, where the plate 40.2 moves out of its plug in position 50.2 of FIG. 27 in the direction of the pullout position 50.1 of FIG. 26. A friction is generated at the contact points 55.2, 56.2 between the end flaps 64.3 or, respectively, 65.3 and the tongue bevels 51.2 or, respectively, 52.2, which friction impedes the outward motion and the folding together motion of the associated two hooks 45.2, 46.2. The previously mentioned longitudinal force 97 between the ramp 95 and the leaf spring 28.2 favors this outward motion. The actuation of the eccentric bolt 30 occurs easily according to the invention.

The case wall 36.2 exhibiting already the ramp generating dent 90, is furnished with an impression which shows a central breakout 99. A funnel structure is generated in the case wall 36.2 based on the impression 98, wherein the funnel structure receives and rotary guides the inner end of the journal 34 of the eccentric bolt 30.

The side case walls 37.2, 38.2 are furnished with notches 100 as shown in FIGS. 21 and 24, wherein the notches 100 direct into the interior of the housing. One of the notches can also be recognized in FIG. 26. Each notch 100 has an apex region 101, wherein oppositely disposed narrow sides of the plate 20.2 in the case interior 21.2 support themselves at the apex region 101. A plate guidance is performed both in the rest position as well as also during the recited longitudinal shifting 86 through this contacting in the apex region 101. This point wise touching decreases also the friction resistance during the longitudinal shifting 86. The fastener 10.1 according to the invention is easily moving in its rotary actuation 33 also for that reason.

### LIST OF REFERENCE CHARACTERS

10.1 fastener
11 profile
12 counter profile
13 undercut groove at 12
14 seat in 11
15.1 case longitudinal direction of 20.1
16.1 first case nose
16.2 first case nose
17.1 second case nose
17.2 second case nose
20.1 first case
20.2 second case
20.3 third case
21.1 interior of the case 20.1
21.2 interior of the case 20.2
22.1 first folding of 20.1
22.2 first folding of 20.2
23.1 second folding of 20.1
23.2 second folding of 20.2
24.1 third folding of 20.1
24.2 third folding of 20.2
25.1 fourth folding of 20.1
25.2 fourth folding of 20.2
26.1 first sheet metal end of 20.1, border profile
26.2 first sheet metal end of 20.2, border profile
27.1 second sheet metal end of 20.1, border profile
27.2 second sheet metal and of 20.2, border profile
28.1 leaf spring of 40.1 for 70.1 (FIG. 7)
28.2 leaf spring at 40.2 (FIGS. 26, 27)
29.1 plate cut out in 40.1 (FIG. 9)
29.2 plate cut out between 41.2, 42.2 (FIG. 26)
30 eccentric bolt
31 cam disk of 30
32 bolt head of 30 (FIGS. 1, 23, 27)
33 rotary actuation of 30 (FIGS. 4, 23)
34 journal of 30
35.1 first broad side of 20.1
35.2 first broad side of 20.2
36.1 second broad side of 20.1
36.2 second broad side of 20.2
36.3 second broad side of 20.3 (FIG. 19)
37.1 first narrow side of 20.1
37.2 first narrow side of 20.2
37.3 first narrow side of 20.3 (FIG. 19)
38.1 second narrow side of 20.1
38.2 second narrow side of 20.2
38.3 second narrow side of 20.3 (FIG. 19)
39.1 inner projection, rotary stop (FIGS. 1, 4)
40.1 plate for 10.1
40.2 plate (FIGS. 26, 27)
41.1 first tongue of 40.1
41.2 first tongue of 40.2
42.1 second tongue of 40.1
42.2 second tongue of 40.2
43.1 third tongue of 40.1
44.1 fourth tongue of 40.1
45.1 first hook at 41.1
45.2 first hook at 41.2
46.1 second hook at 42.1
46.2 second hook at 42.2
47.1 third hook at 43.1
48.1 fourth hook at 44.1
49.1 outer end of 40.1
49.2 outer end at 10.2 (translator's remark: should be 40.2)
50.1 pullout position of 40.1
50.2 plug in position of 40.1
51.1 first bevel at 41.1
51.2 bevel at 41.2
52.1 second bevel at 42.1
52.2 bevel at 42.2
53.1 third bevel at 43.1
54.1 fourth bevel at 44.1
55.1 first contact point for 51.1
55.2 first contact point
56.1 second contact point for 52.1
56.2 second contact point
57.1 third contact point for 54.1
58 stretching force (FIG. 13)
59 stretching counter force (FIG. 13)
60.1 sheet metal blank for 20.1 (FIG. 14)
60.2 sheet metal blank for 20.2 (FIG. 18)
61.1 first free cut in 60.1
61.2 first free cut in 60.2
62.1 second free cut in 60.1
62.2 second free cut in 60.1 (translator's remark: should be 60.2)
63.1 third free cut in 60.1
63.2 third free cut in 60.1 (translator's remark: should be 60.2)
64.1 first end flap at 20.1
64.2 first end flap at 20.2
64.3 end flap at 35.2 (FIG. 23)
65.1 second end flap at 20.1
65.2 second end flap at 20.2
65.3 end flap at 36.2 (FIG. 20)
66.1 third end flap at 20.1
68.1 first edge of 26.1, contour profile (FIG. 14)
68.2 first edge of 26.2, contour profile (FIG. 18)
69.1 second edge at 27.1, contour profile (FIG. 14)
69.2 second edge at 27.2, contour profile (FIG. 18)
70.1 spring loading of 73/30 (FIG. 3)
71.1 widened head at 68.1 or 69.1
71.2 widened head at 68.2 or 69.2
72.1 narrowed neck of 68.1 or 69.1
72.2 narrowed neck of 68.2 or 69.2
73.1 plate inner section of 40.1
73.2 inner section of 20.2 (FIGS. 26, 27)
75 pushbutton press in actuation of 32
76.1 front case end of 20.1
76.2 front case end of 20.2
77.1 rear case end of 20.1
77.2 rear case end of 20.2
78.1 angling off for support at 37.1 and 38.1
78.2 angling off for support at 37.2 and 38.2
78.3 angling off of 37.3, 38.3 (FIG. 19)
79 second angling off for support at 36.3 (FIG. 19)
80.1 fourth free cut (FIG. 14)
81 wall inner face of 36.2 (FIGS. 26, 27)
82 free end of 28.2 (FIGS. 26, 27)
82.1 starting position of 82 (FIGS. 26, 27)
82.2 end position of 82 (FIG. 27)
83 plug receiver in 32 (FIG. 23)
84 force arrow of the spring loading of 32, cross force to 86 (FIG. 26)
85 rotary limit stop at 30 (FIGS. 24, 27)
86 arrow of the longitudinal shifting of 40.2 (FIGS. 26, 27)
87 inner carrier shoulder between 40.2, 31 (FIG. 26)
88 outer carrier shoulder between 40.2, 31 (FIG. 26)
89 plate breakout in 40.2 for 30 (FIG. 27)
90 dent in 36.2 (FIGS. 26, 27)
91 end side loop for 87 (FIGS. 23, 27)
92 tappet at 78.2 (FIGS. 20, 21, 24)
93 hole for 92 in 36.2 (FIG. 20)
94 region of the support face for 82 (FIG. 27)
95 ramp in 94 for 28.2 (FIGS. 26, 27)
96 contact point between 28.2, 95 (FIG. 27)
97 longitudinal force acting in the pullout sense of 40.2 (FIG. 27)
98 impression in 36.2 for 34, funnel structure (FIGS. 20, 27)
99 central hole in 98
100 notch in 37.2, 38.2 (FIGS. 21, 24, 26)
101 apex region of 100 (FIGS. 21, 24)

1. Fastener (10.1) for disconnectably connecting of a profile (11) at a counter profile (12)
with an eccentric bolt (30) rotary supported in the housing, wherein the eccentric bolt (30) exhibits besides a cam disk (31) disposed in the interior (21.1) of the housing also yet a bolt head (32) projecting out of the housing for rotary actuation (33), with a plate (40.1) in the housing, which plate (40.1) is longitudinally shiftable between a pullout position (50.1) and a plug in position (50.2) by a cam disk (31), with at least one hook (45.1) at the outer end (49.1) of the plate (40.1), wherein the hook (45.1) protrudes from the housing,
and with at least one bevel (51.1) running at an angle relative to the longitudinal shifting at the plate (40.1), wherein the plate (40.1) supports itself at the contact point (55.1) of the housing and moves the hook (45.1) cross behind the groove wall in the counter profile (12) during insertion,
and with an inner section (73.1) at the plate (40.1), wherein the inner section (73.1) is penetrated by the eccentric bolt (30),
characterized in that
the housing is a case (20.1) open at both ends, wherein the case is formed out of a sheet metal blank (60.1) by multiple bending (22.1 through 25.1) and wherein the case consists preferably of steel,
wherein the two sheet metal ends (26.1,27.1) of the sheet metal blank (60.1) butting against each other in the case (20.1) grip shape matching into each other or are connected force matching to each other,
wherein the form closure or the force closure of the sheet metal ends (26.1, 27.1) is directed against the resulting stretching and expanding (58,59) of the case (20.1) upon an overturning of the cam disk (31) and prevents a bending up of the cantings off (22.1 through 25.1) of the sheet metal blank (60.1),
and that at least one bending off (64.1) from the wall end pieces is furnished at least at the front end (76.1) of the case, wherein the bending off (64.1) generates the contact point (55.1) for the plate bevel (51.1),
characterized in that
the housing is formed out of a single piece of sheet metal,
wherein at the two sheet metal ends (26.1, 27.1) of the canting sheet metal blank (60.1) there are generated two edges (68.1, 69.1) running in longitudinal direction (15.1) of the case, wherein the edges (68.1, 69.1) grip into each other and form shape matching,
and wherein the two edges (68.1, 69.1) gripping into each other exhibit an undercut border profile, wherein the border profile of the one edge (68.1) is formed complementary to the border profile of the other edge (69.1).

2. (canceled)

3. (canceled)

4. Fastener according to claim 1, characterized in that the case (20.1) exhibits a rectangular cross-section and comprises in each case two opposite to each other disposed broad walls (35.1, 36.1) and narrow walls (37.1,37.2),
wherein the bending off (64.1) is formed by an end flap of the broad wall (35.1), wherein the end flap (64.1) is cut free (61.1 through 63.1; 80.1) and runs with its free flap end inclined in the interior (21.1) of the case,
and wherein the flap end generates the contact point (55.1) for the plate bevel (51.1).

5. Fastener according to claim 1, characterized in that the two sheet metal ends (26.1, 27.1) of the sheet metal blank (60.1) forming the case (20.1) are disposed in a common plane and their edge profile (68.1, 69) runs flush with the surface at the two sheet metal ends (26.1, 27.1).

6. Fastener according to claim 5, characterized in that the common plane for the shape matching is the one broad wall (35.1) of the case (20.1).

7. Fastener according to claim 1, characterized in that the two edges (38.1, 39.1) gripping into each other exhibit a complementary meander profile or a complementary T-contour profile,
wherein the arches of the meander profile for the step contour of the contour profile comprises a to broadened head (71.1) with a narrowed neck (71.2).

8. Fastener according to claim 1, characterized in that the two sheet metal ends of the sheet metal strip forming the case (20.1) are disposed in two planes located perpendicular to each other,
and wherein the shape matching of the sheet metal ends is disposed in an edge of the case (20.1) generated from the sheet metal strip.

9. Fastener according to claim 7, characterized in that one plate is formed by the broad wall (35.1) of the case (20.1) and that the other plate is formed by its adjoining narrowed wall (37.1).

10. Fastener according to claim 4, characterized in that the broad wall (35.1) of the case (20.1) is furnished with an inner projection (39.1), which inner projection (39.1) serves as a rotary stop for the cam disk (31) and wherein the inner projection (39.1) limits the rotation (33) of the cam disk (31) in the plug in position (50.2) of the plate and/or the pullout position (50.1).

11. Fastener according to claim 9, characterized in that the inner projection (39.1) is formed as a bead in the broad wall (35.1) of the case (20.1).

12. Fastener according to claim 1 one of the claims 1 through 10, characterized in that an inner section (73.1) of the plate (14.1) serves for placing the cam disk (31),
wherein the force of the plate inner section (73.1) acts by spring loading (70.1) perpendicular to the longitudinal shifting direction,
wherein the cam disk (31) resting at the plate inner section (73.1) presses the bolt head (32) axially into a cross bore hole of the profile (11) in order to secure the fastener (10.1) in a mounted position at the receiver (14) of the profile (11),
wherein the bolt head (32) can be pressed into the interior (21.1) of the case against the spring loading (720.1) of the bolt head (32) if the plate (40.1) is disposed in its pullout position,
wherein at least one angling off (78.1) of the sheet metal blank (60.1) is provided at the rear case end (77.1) disposed opposite to the bending off (64.1 through 66.1), and wherein the angling off (78.1) in the plug in position of the plate (40.1) serves as a support for the plate inner end (73.1) in order to block the actuation of the push button of the bolt head (32).

13. Fastener according to claim 11, characterized in that the angling off (78.1) of the sheet metal blank (60.2) is generated by a wall extension of the narrowed wall (37.1, 38.1) of the case (20.1).

14. Fastener according to claim 11, characterized in that double superposed anglings off (78.3, 79) of the sheet metal blank are disposed at the rear case end (77.3), wherein the anglings off together form a support for the push button blockade of the plate inner end.

15. Fastener according to claim 13, characterized in that the second angling off (79) of the sheet metal blank is formed as a wall extension of the broad wall (36.2) of the case (20.3), wherein the angling off (79) generates the double angling off in the sheet metal blank and operates as a support.

16. Fastener according to claim 1, characterized in that an inclined running leaf spring (28.2) is seated at the plate inner end (73.2), wherein the leaf spring (28.2) presses the bolt head (32) perpendicular to the longitudinal shifting direction (86) out of the case (20.2), whereby a perpendicularly directed cross force (84) effective at the bolt head (32) is generated.

17. Fastener according to claim 1, characterized in that the free end (82) of the leaf spring (28.2) is supported at the case inner face (81) and slides along at this support face (84) between two positions (82.1, 82.2) upon longitudinal shifting (86) of the plate (40.2), namely a starting position (82.1) in the pullout position (50.1) of the plate (40.2) and an end position (82.2) in the plug in position (50.2).

18. Fastener according to claim 1, characterized in that at least in certain regions the support face (94) for the leaf spring end (82) comprises a ramp (95) rising in the direction of the end position (82.2),
and wherein the leaf spring end (82) lies in the end position on the ramp (95) and the inclined leaf spring (28.2) exerts a longitudinally directed, in the pullout sense effective, longitudinal force (97) on the plate (40.2).

19. Fastener according to claim 1, characterized in that the leaf spring end (82) rests at a position outside of the ramp (95) in the starting position (82.1), wherein the ramp (95) is disposed lower as compared with the end position (82.2).

20. Fastener according to claim 1, characterized in that the ramp (95) is formed by a dent (90) in a case wall (36.2), wherein the dent is directed toward the interior (21.2) of the housing.

21. Fastener according to claim 1, characterized in that the same case wall (36.2), which is furnished with the ramp (95), exhibits also yet an impression (98) with a central hole (99), and wherein the impression (98) generates a funnel structure in the case wall (36.2), which serves as a rotary guide for the inner end (34) of the eccentric bolt (30).

22. Fastener according to claim 1, characterized in that at least one angled off shoulder (78.2) is formed out of at least a rear extension of the case wall (37.2, 38.2), wherein the shoulder points with its shoulder end toward the interior (21.2) of the case,
wherein the shoulder (78.2) serves as a support for the plate inner end in the plug in position (82.2) of the plate (40.2) and blocks a push button actuation of the bolt head (32),
and wherein an undesired demounting of the housing case (20.2) is prevented from the receiver in the profile.

23. Fastener according to claim 1, characterized in that the tappet (92) is seated at the shoulder (78.2), wherein the tappet engages in a breakout (93) in the neighboring case wall (36.2) and thereby stabilizes the angle position of the shoulder (78.2).

24. Fastener according to claim 1, characterized in that at least a notch (100) is inserted at certain positions in the case wall (37.2, 38.2) and points to the interior (21.2) of the housing, and wherein the notch (100) touches the plate (40.2) at the interior (21.2) of the case with its apex region (101) and wherein the notch (100) guides the plate (40.2) during the plate longitudinal shifting (86).

25. (canceled)

26. Device for attachment of the fastener (10.1) according to claim 1,
at a counter profile (12), wherein the counter profile (12) has an undercut groove (13) and wherein the profile (11) has a receiver (14) for a housing of the fastener (10.1) characterized in that
the plate (40.1) is subdivided into several longitudinally running tongues (41.1 through 44.1) in the region of its outer end (49.1),
wherein the tongue end pieces in each case exhibit a bevel (51.1 through 53.1) and a hook (45.1 through 48.1) of which at least one in the one direction and at least a second one in the opposite direction is cranked and bent off,
wherein at least two relative to each other oppositely running contact points (55.1 through 57.1) of the case (20.1) are coordinated to the bevels (51.1, 54.1, 52.1, 53.1) having a counter sense relative to each other,
wherein the groove in the counter profile (12) is delimited by two groove walls (18, 19) and wherein the hooks (45.1 through 48.1) grip behind two groove walls of the counter profile (12) in the plug in position (50.2) of the plate (40.1),
and wherein the two contact points (55.1 through 57.1) are formed by the flap ends of several end flaps (64.1, 66.1), which are formed by the two oppositely disposed broad walls (55.1, 56.1) of the case (20.1).

27. Device according to claim 26, characterized in that the shape matching of the sheet metal ends (26.1, 27.1) are disposed in the middle of that case wall (36.1), which case wall (36.1) runs in a parallel plane to the eccentric cam disk (31).

28. Device according to claim 26, characterized in that the common plane for the shape matching is a broad wall (35.1) of the case (20.1).
